(19) United States
(12) Patent Application Publication
(10) Pub. No.: US 2023/0135857 A1
(43) Pub. Date: May 4, 2023

(54) Mechanism For Baiting Bags On A Trotline

(71) Applicant: Joel Denny, Centreville, MD (US)

(72) Inventor: Joel Denny, Centreville, MD (US)

(21) Appl. No.: 17/519,467

(22) Filed: Nov. 4, 2021

(51) Int. Cl. A01K 91/18; A01K 97/04; A01K 91/02

(52) U.S. Cl. CPC A01K 91/18; A01K 97/04; A01K 91/02

(57) ABSTRACT

A bag to contain bait, which is to be used with a trotline, is disclosed. The bag comprises a continuous side wall which defines an interior region, a primary opening, a plurality of secondary openings, and a tertiary opening. The bag includes a slide fastener secured to the side wall and surrounding the tertiary opening. Also disclosed is a mechanism, to be used with a predetermined length of the trotline which has a plurality of such bags secured to the trotline at spaced-apart intervals.

### FIELD

The field of my invention (which I shall refer to as the present subject matter hereafter), in general, relates to trotline crabbing. More particularly, the present subject matter relates to a particular trotline crabbing mechanism that I developed to greatly reduce the amount of time that trotline crabbers normally require to bait the bags on their trotlines. The present subject matter also includes my bag design.

### BACKGROUND

A trotline is a simple system consisting of a line of heavier cord that can be made of woven fibers which, in the past, were typically cotton fibers but at the present time are frequently synthetic or polymeric fibers. There are many, like myself, who use trotlines to catch crabs. “Trotline crabbers,” as we are called, will attach 400-700 bags, each containing 3-6 clams at spaced intervals along a trotline.

To illustrate the basic principle of trotline crabbing, I shall now briefly refer to FIG. 1 of U.S. Pat. No. 5,157,858 (to Lockner et al.), which, of course, is prior art.

A crab line roller mechanism 10, attached to and outwardly extending from an upper surface 16 of a boat 12, is used to raise and guide a trotline 18 out of the water 14. The trotline 18 of FIG. 1, illustrating trotline crabbing as practiced by trotline crabbers of at least a generation ago, shows bait 20 directly attached to the trotline 18. At that time, the bait 20 was usually decaying chicken or eel. (Currently, trotline crabbers use clams, inserted into bags secured to the trotline, as bait.) The bait 20 lures a crab 15, which begins feeding. The trot line 18 is then raised to the surface of the water 14, enabling the crabber 17 to catch the crab 15 with a net 19.

While current trotline crabbers work from a larger boat and use equipment more sophisticated than what is shown in FIG. 1, their efficiency is restricted by time needed to bait their trotlines, a “problem” that the present subject matter solves.

For the present subject matter, my reference to the term “bag” shall mean a container having a “special” opening that can be closed to secure the bait within, and often made of a synthetic or a polymeric material. Also, the sides of such bags include many, much smaller, openings to attract crabs to the bait contained within.

### SUMMARY

Current trotline crabbers generally use a trotline of about 3,000-4,000 feet in length (with 3,600-foot lengths being common), and having about 400-700 bags (or about 500-600 bags) attached to the trotline, at approximately equally-spaced intervals. These trotline crabbers also generally use mesh bags open at one end and made of synthetic materials, with mesh bags made from polymeric materials being preferred. While illustrative synthetic materials include basalt fiber and glass fiber, preferred polymeric materials include aramid, cellulose, nylon, and rayon material.

Currently, trotlines are baited manually. An entire length of trotline, with all bags attached thereto containing “spent” bait, requires removal of each bag from the line to discard the spent bait contained therein, next substituting “fresh” bait for the discarded bait, and finally re-attaching each “fresh” bait-filled bag manually along the entire length of the trotline. As a result, it will take a professional crabber about 3-5 hours or more to manually re-bait a single trotline, which greatly reduces the amount of time a trotline crabber is able to use a trotline to catch crabs, to sell.

The term “spent” bait shall refer to bait which has been drawn through the water on a trotline, and which is no longer able to serve as an attractant to a crab.

Another “problem” the present subject matter solves is a problem inherent in the design of plastic mesh bags presently favored by trotline crabbers. Briefly, each mesh bag is an elongated sleeve of polymeric mesh material, which is closed at one end and open at the opposite end. Current conventional bag design requires a trotline crabber to first “load” a mesh bag with “fresh” bait, and thereafter discard “spent” bait from each mesh bag on a trotline. Because each “spent” bait-filled bag is manually removed from the trotline, and thereafter manually re-attached to the trotline, after fresh bait is substituted for spent bait, a significant amount of time is spent by trotline crabbers re-loading all the bags on the trotline with “fresh” bait.

To solve the current trotline crabbing problem associated with the removal and re-attachment of a bag of above-described design, the present subject matter includes my bag of novel design. Briefly, the bag of the present subject matter comprises a continuous side wall defining an interior region; a “special” opening dimensioned for inserting bait into the interior region; and a slide fastener fixed to the side wall and surrounding the “special” opening, to enable the slide fastener to be used to open and close the “special” opening when a bag is secured to a trotline.

Refilling a bag of my present design doesn't require removal from a trotline.

While a zipper is well known and preferred, the present subject matter extends to the broader term “slide fastener,” a mechanism comprising two parallel tracks of teeth or coils, interlockable or separable by pulling a slide between them.

### BRIEF DESCRIPTION OF THE DRAWINGS

FIG. 1, dated prior art, is used an illustrative example of trotline crabbing.

FIG. 2 is a recent snapshot of a conventional trotline crabber netting a crab.

FIG. 2A and FIG. 2B, also recent snapshots, depict the conventional trotline crabber re-loading a conventional bait bag according to conventional process steps.

In FIG. 2C, yet another recent snapshot, a knot formed in trotline is shown.

In FIG. 2D, another recent snapshot, a conventional bait bag is presented.

FIG. 3, a recent snapshot, depicts a bait bag of the present subject matter.

FIG. 4A and FIG. 4B, also recent snapshots, show a person using a mechanism of the present subject matter to re-load the bait bags of the present subject matter.

FIG. 5A is a frontal view of the mechanism of the present subject matter.

FIG. 5B and FIG. 5C are front and back views, respectively, of the mechanism.

FIG. 5D presents a side of the mechanism shown in FIG. 5A, from the right.

FIG. 5E presents a side of the mechanism shown in FIG. 5A, from the left.

FIG. 5F depicts a feature of the mechanism of the present subject matter.

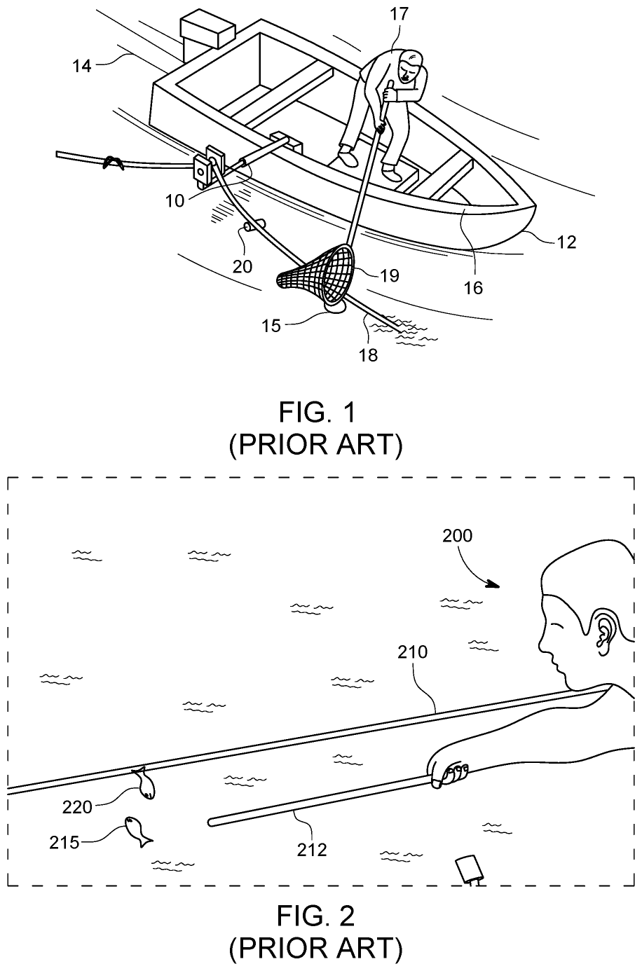

While the present subject matter shall now be described in connection with various illustrated embodiments, which include the present drawing figures, it is to be understood that the present subject matter is not to be limited to the illustrated embodiments. On the contrary, the present subject matter shall be understood to include all modifications as are deemed to be within the scope of appended claims.

### DETAILED DESCRIPTION

Before describing the present subject matter, I would like to provide a few visual images and details of current trotline crabbing practice, to help in understanding why the present subject matter—including my novel bag design, and my novel mechanism for re-baiting trotlines used by crabbers—will likely be viewed by most commercial trotline crabbers as much-needed, time-saving articles of manufacture as soon as they are able to become widely commercially available.

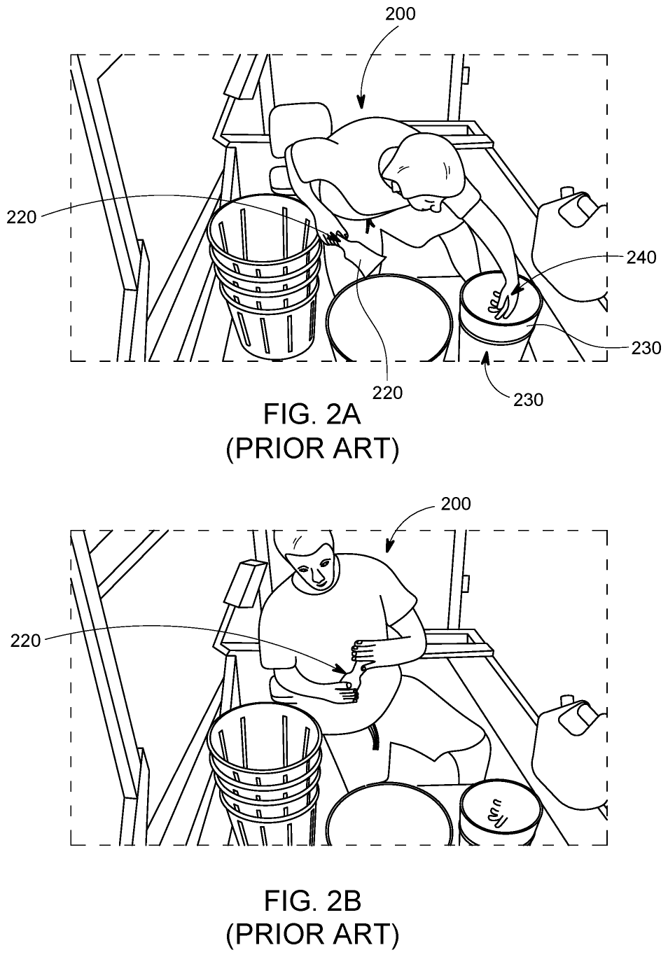

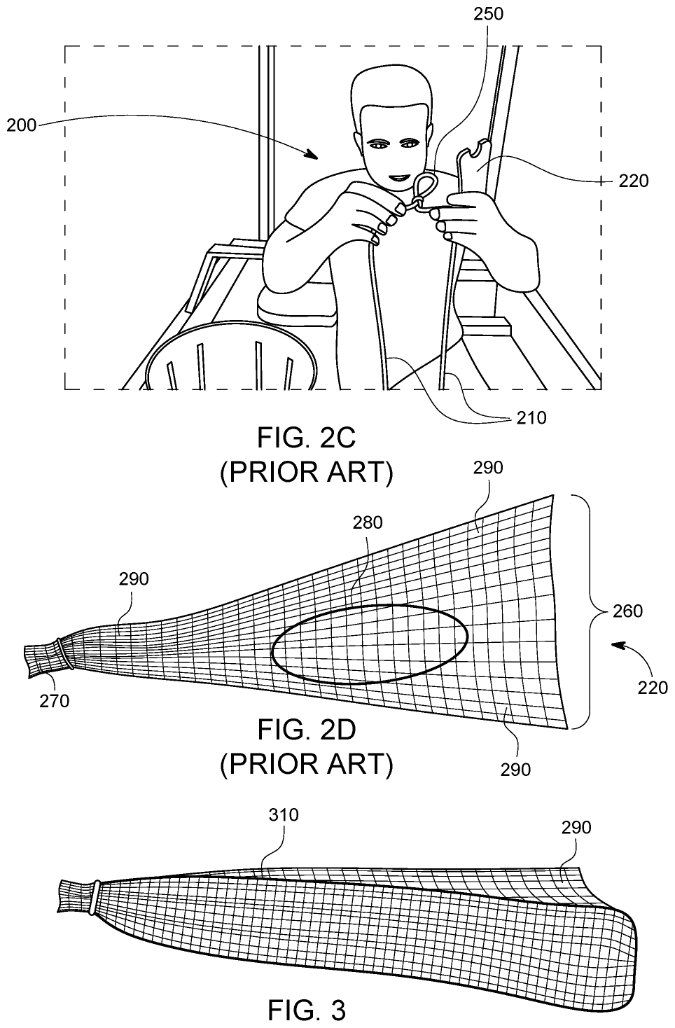

In FIG. 2, is shown a current trotline crabber 200 using a conventional trotline 210 and crab-catching net (not visible, since it is submerged in the water) to “catch” a crab 215 which had been attached to a conventional bag 220 prior to the trotline crabber 200 extending the net (not visible) attached to the handle 212.

In FIG. 2A, while seated on a modern boat, a current trotline crabber 200 is shown reaching into a bucket 230 to grasp with a left arm a handful of clams 240 that the trotline crabber 200 will insert into a conventional bag 220 held by his right hand. In FIG. 2B, the trotline crabber 200 is shown, after having inserted the handful of clams (no longer visible) into the conventional bag 220 in his right hand.

In FIG. 2C, the trotline crabber 200 displays knot 250 in the trotline 210. The knot 250 is used to secure conventional bag 220 along a length of trotline 210.

In FIG. 2D, a conventional bag 220 is shown as having an elongated shape, with a primary opening 260 at one end portion, a closed opposite end portion 270, and a plurality of openings 280 (a number of which are shown as being encircled in FIG. 2D) essentially along the entire side wall 290 of the conventional bag 220. In other words, the conventional bag shown is a custom-made sleeve of plastic mesh.

The present subject matter thus includes my novel “improvement” upon the conventional bag design. The usefulness of my improvement will become clear upon reading my description of how my novel improvement greatly reduces the significant amount of time a trotline crabber must devote to re-baiting a trotline.

Briefly referring to FIG. 3, showing my novel bag 300, please note that my novel design comprises a zipper 310 (which I have encircled) along an entire length of bag 300 which, at this time, includes the structural components associated with a conventional bag discussed above in connection with FIG. 2D. Hidden by zipper 310 is an opening, which I call a tertiary opening, along a length of a conventional bag, for “loading” my novel bag 300 with “fresh” bait. Presently, the zipper 310 is stitched to the tertiary opening, to enable a person to close the tertiary opening of my novel bag 300 after “loading” a bag 300 with “fresh” bait. Later, when the bait becomes “spent,” meaning that the bait is no longer able to attract a crab to the trotline, the zipper 310 enables a person to open my bag 300 for discarding the “spent” bait, and thereafter “re-loading” my bag 300 with “fresh” bait. Also please note that my novel bag design contemplates “closing” the primary opening, as was described in relation to the “opposite end” portion 270 (shown above in FIG. 2D).

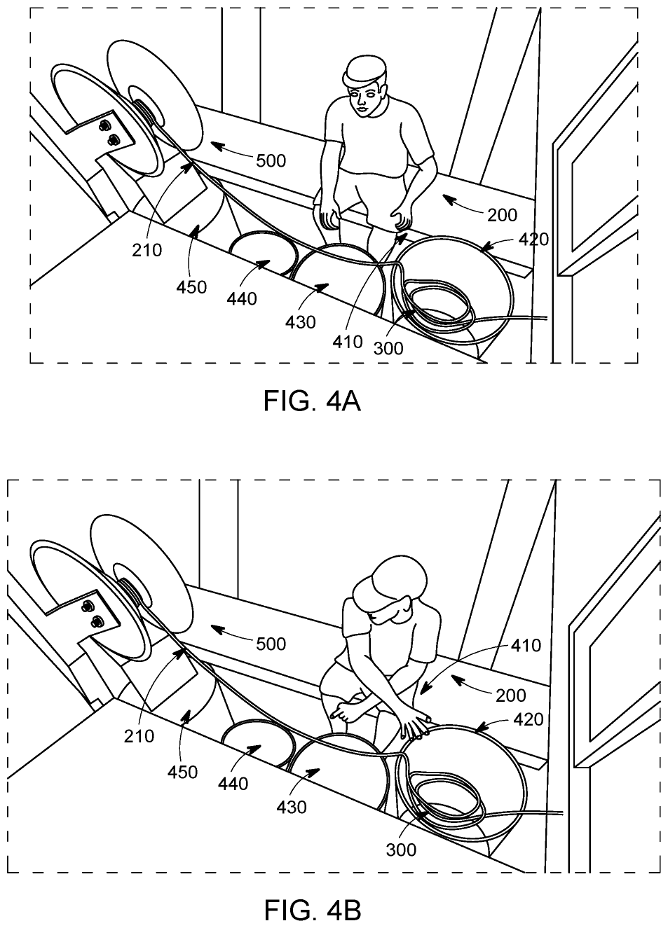

Attention is next directed to FIGS. 4A and 4B, which illustrate not only a time-saving advantage of the present subject matter but also certain other features of the present subject matter. For instance, instead of interrupting a trotline crabber (who ordinarily would be harvesting crabs), to “re-load” bags containing “spent” bait—with “fresh” bait—a trotline crabber 200 or another person can very easily use my trotline baiting mechanism 500 to re-load bags containing spent bait.

In particular, my mechanism 500 is portable and, as a result, can be located anywhere. In my “preferred” location, shown in FIGS. 4A and 4B, there is a chair 410 on which a person can sit, and a bucket 420 containing bags 300 on a trotline. While seated, a person can easily reach into bucket 420 with one hand (as illustrated by FIG. 4B) to fetch a bag 300 still on the trotline, next zip-open the fetched bag 300, discarding “spent” bait in container 430, next fetching from a surface 440 “fresh” bait and then inserting “fresh” bait into the zipped-open bag 300, next zipping the “fresh” bait-containing bag 300 closed, and then using a foot-pedal component of my mechanism 500 to advance “fresh” bait-containing bags 300 to receptacle 450.

Each one of the plurality of bags 300 (FIGS. 4A and 4B) is removably secured to the trotline 210 at an interval that is spaced (preferably equally spaced) from the two nearest ones of the plurality of bags 300 on the trotline 210. Presently, for my prototype design of the present subject matter, each bag 300 is removably secured to the trotline via a knot 250, as illustrated in FIG. 2C. Yet, it is clear that the scope on my subject matter contemplates other mechanisms for removably securing bags 300 to a trotline 210, including mechanisms to simply “fix” bags 300 to a trotline 210, if the removal of bags 300 from trotline 210 is found to be totally unnecessary.

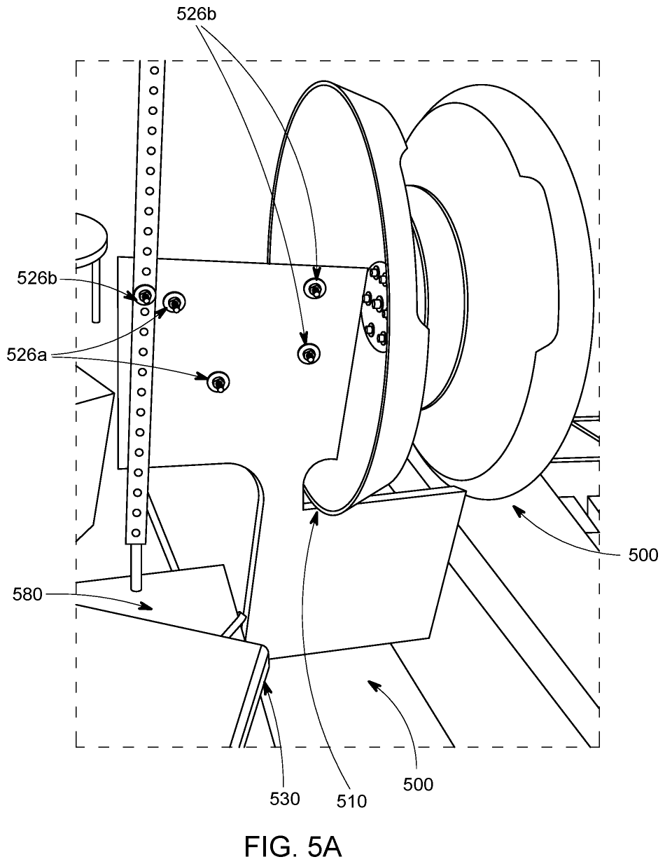

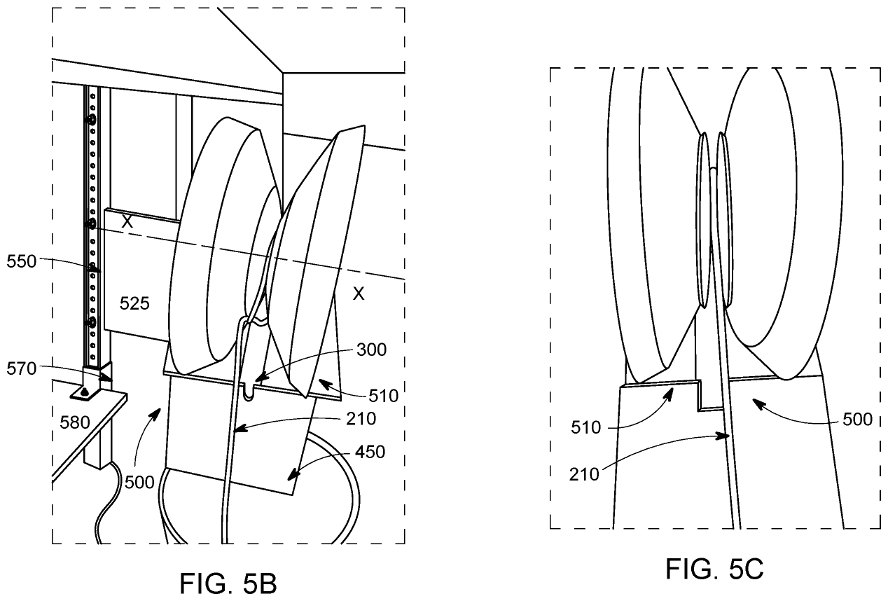

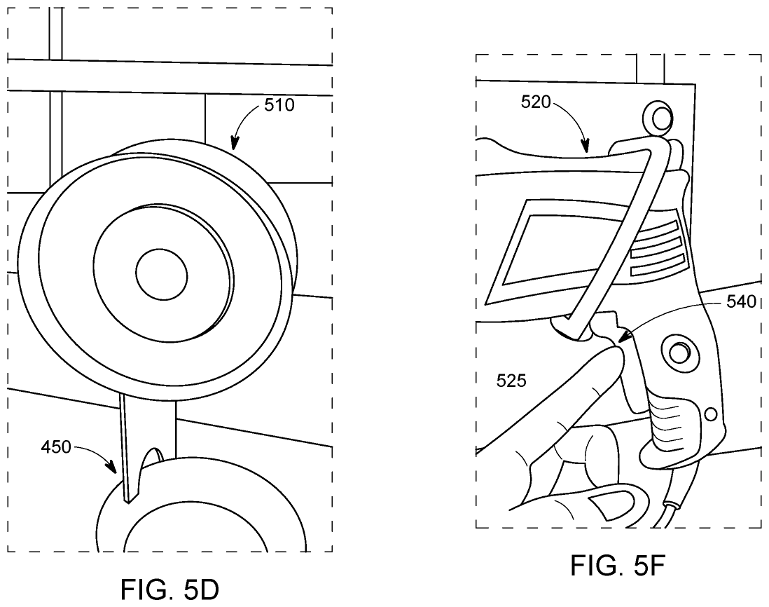

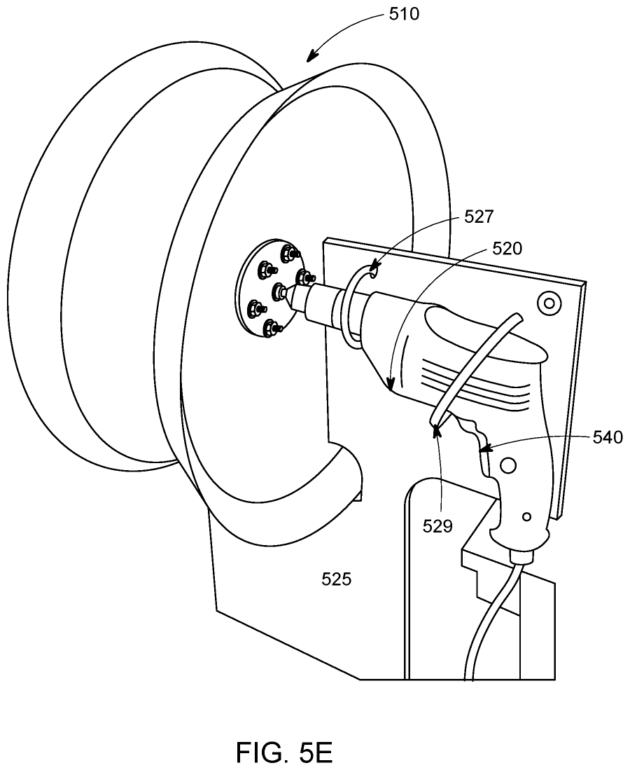

Finally, attention is directed FIGS. 5A, 5B, 5C, 5D, 5E, and 5F, which I shall now use to provide details of a current prototype of my trotline baiting mechanism 500 which I designed to be used with a predetermined length of trotline 210 having a plurality of bags 300 secured thereto at spaced-apart intervals (see FIGS. 4A, 4B). Mechanism 500 comprises a reel 510 rotatable about an axis “X-X” (see FIG. 5B) for transferring from a first location, such as person on chair 410 (see FIGS. 4A, 4B), to a second location, such as the receptacle 450 (see FIGS. 4A, 4B, 5B, and 5D).

Mechanism 500 further includes a motor for powering rotation of reel 510 about the axis “X-X” with a preferred motor for my prototype, being provided by a conventional hand-held drill 520 (see, e.g., FIG. 5E) secured to a surface of a support structure 525 by brackets 527 and 529 (see FIG. 5E) secured to the support structure 525 by appropriately-dimensioned threaded-fastener components 526A and 526B (FIG. 5A), wherein the brackets 527 and 529 themselves are dimensioned and arranged to securely maintain rotation of reel 510 about axis “X-X” (FIG. 5B).

Mechanism 500 additionally includes an on/off mechanism illustrated by conventional foot-pedal mechanism 530 (FIG. 5A) operatively connected to drill 520 (see, e.g., FIG. 5E) as well as to a conventional power source (not shown), which provides electricity to power drill 520. In addition, the conventional hand-held drill 520, a component of my mechanism 500, includes a trigger 540 (see, e.g., FIG. 5F) to adjust, then “set” the rotational speed of the reel 510 about axis “X-X” (FIG. 5B).

Mechanism 500 further includes a stand 550 (see, e.g., FIG. 5A) to which the support structure 525 is secured by threaded-fastener components 560A and 560B. The stand 550, in turn, is securely held in place by a mount 570. Mount 570, in turn, is securely clamped to a work table 580 by a mechanism (unitary with mount 570 but not visible in the figures, since the mechanism is on the underside of table 580).

Thus, a person sitting in chair 410 (FIGS. 4A, 4B), is able to reach into bucket 420 to fetch a bag 300 on trotline 210, use zipper 310 (FIG. 3) to open the bag 300 to discard “spent” bait, re-load the bag 300 with “fresh” bait, and then use the zipper 310 to close the “fresh” bait-loaded bag 300, and then use the foot-pedal mechanism 530 (FIG. 5A) until the next adjacent bag 300 on trotline 210 is close enough to the person sitting in chair 410 to repeat the process steps just described.

Summarizing the above, when the mechanism 500 is operated by a person in a manner to achieve the process steps described above, the mechanism 500 can very easily be used by an average person to substitute “fresh” bait for “spent” bait for a plurality of bags 300, located at spaced-apart intervals along the length of a trotline 210, much faster than is conventionally done at the present time. Moreover, since my mechanism 500 is not required to be on a trotline crabbing vessel, a trotline crabber (on the vessel) is freed-up to engage in trotline crabbing.

### Alternatives, Changes and Modifications

What has been illustrated and described is a novel mechanism to be used with a novel bag that enables quickly substituting “fresh” bait for “spent” bait in the bag, with a plurality of the novel bags being secured along a length of trotline. Yet, while the present subject matter has been described with reference to various exemplary embodiments, the present subject matter is not to be limited to these embodiments. On the contrary, many alternatives and modifications shall become apparent to one of ordinary skill in this particular field after reading the foregoing description. It has therefore occurred to me to now state unequivocally that such alternatives and modifications are to be considered as forming a part of the present subject matter insofar as they fall within the spirit and scope of appended claims.

1. A bag to contain bait and to be used with a trotline, wherein the bag comprises:
a continuous side wall defining:
an interior region,
a primary opening,
a plurality of secondary openings, each sized to permit an essence of bait within the interior region to flow through the plurality of secondary openings, for purposes of attracting at least one crab to the side wall, and to feed upon the bait contained within the interior region, and
a tertiary opening dimensioned to insert bait in the interior region, and
a slide fastener secured to the side wall and surrounding the tertiary opening, wherein the slide fastener is configured to be used to close and to re-open the tertiary opening while the bag is secured to a trotline.

2. The bag of claim 1, wherein the primary opening is closed.

3. The bag of claim 1, wherein the bag is removably secured to a trotline.

4. The bag of claim 1, wherein the bag is removably secured to a trotline by a knot formed in the trotline.

5. The bag of claim 1, wherein the bag is made of a polymeric material.

6. The bag of claim 1, wherein the slide fastener is a zipper.

7. A trotline baiting mechanism to be used with a predetermined length of trotline having a plurality of bags secured thereto at spaced-apart intervals comprising:
a reel rotatable about an axis for transferring from a first location to a second location at least a portion of the trotline to which is secured at least a portion of the plurality of bags; and
a motor for powering rotation of the reel about the axis.

8. The trotline baiting mechanism of claim 7, wherein each one of the plurality of bags is removably secured to the trotline at an interval that is spaced from two nearest ones of the plurality of bags.

9. The trotline baiting mechanism of claim 8, wherein each one of the associated plural intervals is spaced from the two nearest ones of the plurality of bags.

10. The trotline baiting mechanism of claim 8, wherein each one of the plurality of bags is removably secured to the trotline by a knot formed in the trotline.

11. The trotline baiting mechanism of claim 7, further including an on/off mechanism configured for providing a user with on/off control of the motor.

12. The trotline baiting mechanism of claim 11, wherein the on/off mechanism is configured to enable a user to engage a pedal to cause the control of the motor.

13. The trotline baiting mechanism of claim 12, wherein a foot is used to engage the pedal, thereby causing the control of the motor.

14. The trotline baiting mechanism of claim 7, wherein the motor is provided by operation of a hand-held drill, and wherein the mechanism further comprises:
a stand for rotatably mounting the reel for rotation about the axis, wherein the stand includes a surface to which the drill is removably secured.

15. The trotline baiting mechanism of claim 14, wherein the hand-held drill includes a trigger mechanism for controlling rotational speed of the reel about the axis.

16. The trotline baiting mechanism of claim 7, wherein at least one bag of the plurality of bags comprises:
a continuous side wall defining:
an interior region,
a primary opening,
a plurality of secondary openings, each sized to permit an essence of bait within the interior region to flow through the plurality of secondary openings, for purposes of attracting at least one crab to the side wall, and to feed upon the bait contained within the interior region, and
a tertiary opening dimensioned to insert bait in the interior region, and
a slide fastener secured to the side wall and surrounding the tertiary opening, wherein the slide fastener is configured to be used to close and to re-open the tertiary opening while the at least one bag is secured to the trotline.

17. The mechanism of claim 16, wherein the at least one bag of the plurality of bags is removably secured to the trotline.

18. The mechanism of claim 16, wherein the primary opening is closed.

19. The mechanism of claim 16, wherein the at least one bag of the plurality of bags is made of a polymeric material.

20. The mechanism of claim 16, wherein the slide fastener of the at least one bag of the plurality of bags is a zipper.
